(19) United States
(12) Patent Application Publication
(10) Pub. No.: US 2020/0077766 A1
(43) Pub. Date: Mar. 12, 2020

(54) Illuminated Compact Case

(71) Applicant: Albert Souvorov, Burbank, CA (US)

(72) Inventor: Albert Souvorov, Burbank, CA (US)

(21) Appl. No.: 16/128,249

(22) Filed: Sep. 11, 2018

(51) Int. Cl. A45D 33/32; F21L 4/08; F21V 23/06; A45D 42/04; A45D 40/24

(52) U.S. Cl. CPC A45D 33/32; F21L 4/08; F21Y 2105/16; A45D 42/04; A45D 40/24; F21V 23/06

(57) ABSTRACT

An illuminated compact case for magnetically holding makeup pans includes a housing that has a bottom, which is magnetic, and a top that is open. A lid is hingedly coupled to a back edge of the housing. A mirror that is coupled to the lid defines a border between the mirror and a perimeter of the lid. At least one battery, which is rechargeable, is coupled to the housing. A USB port that is coupled to the housing and operationally coupled to the battery is configured to couple the battery to a source of direct current to recharge the battery. A plurality of light emitting diodes is coupled to the border and is operationally coupled to the battery to selectively illuminate an area proximate to the lid. The top is configured to insert paramagnetic articles into the housing to selectively couple the paramagnetic articles to the bottom.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to compact cases and more particularly pertains to a new compact case for magnetically holding makeup pans.

### BRIEF SUMMARY OF THE INVENTION

An embodiment of the disclosure meets the needs presented above by generally comprising a housing that has a bottom, which is magnetic, and a top that is open. A lid is hingedly coupled to a back edge of the housing. A mirror that is coupled to the lid defines a border between the mirror and a perimeter of the lid. At least one battery, which is rechargeable, is coupled to the housing. A USB port that is coupled to the housing and operationally coupled to the battery is configured to couple the battery to a source of direct current to recharge the battery. A plurality of light emitting diodes is coupled to the border and is operationally coupled to the battery to selectively illuminate an area proximate to the lid. The top is configured to insert paramagnetic articles into the housing to selectively couple the paramagnetic articles to the bottom.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an illuminated compact case according to an embodiment of the disclosure.

FIG. 2 is a side view of an embodiment of the disclosure.

FIG. 3 is a top view of an embodiment of the disclosure.

FIG. 4 is a detail view of an embodiment of the disclosure.

FIG. 5 is a cross-sectional view of an embodiment of the disclosure.

FIG. 6 is a block diagram of an embodiment of the disclosure.

### DETAILED DESCRIPTION OF THE INVENTION

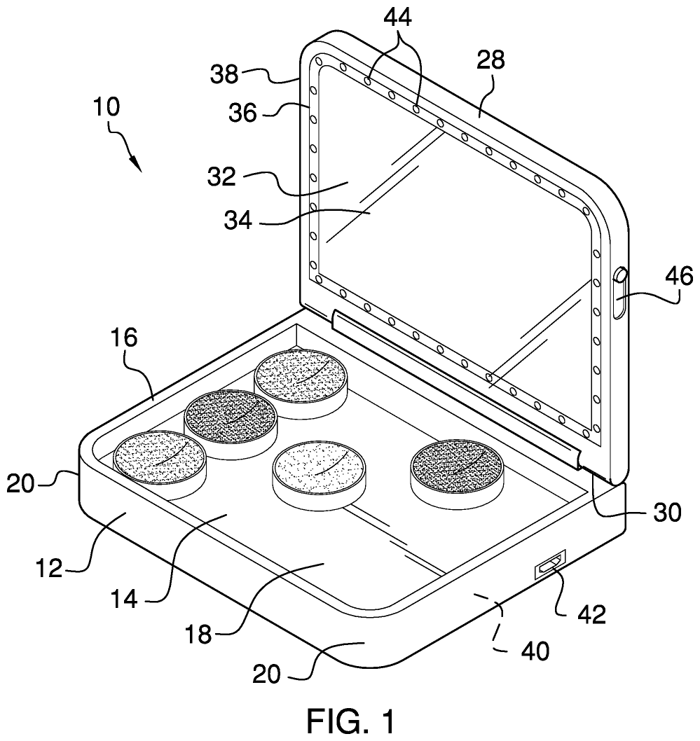

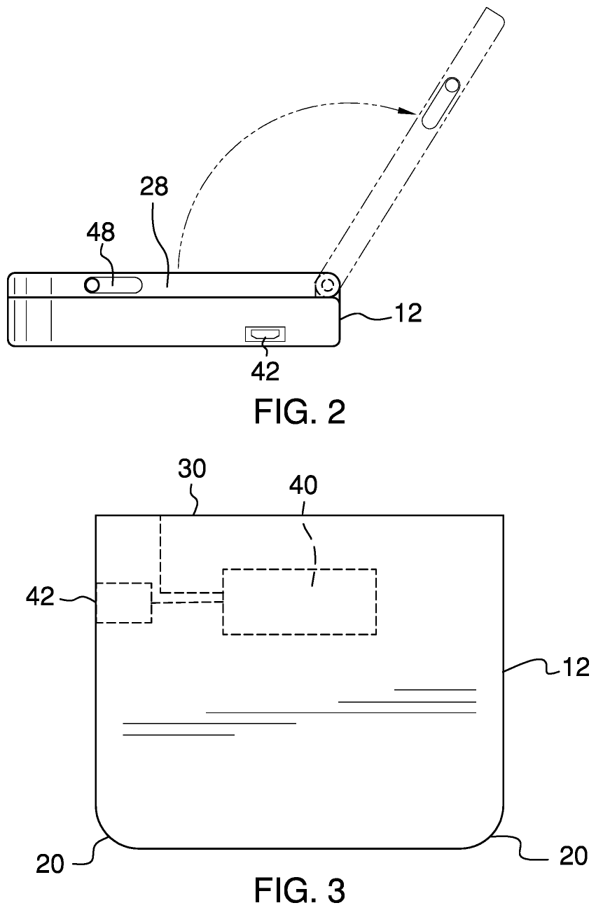

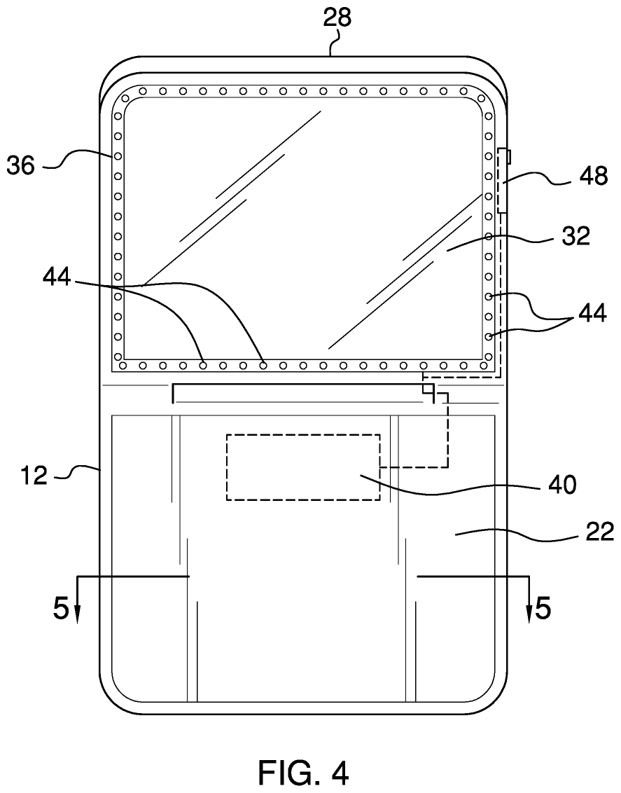

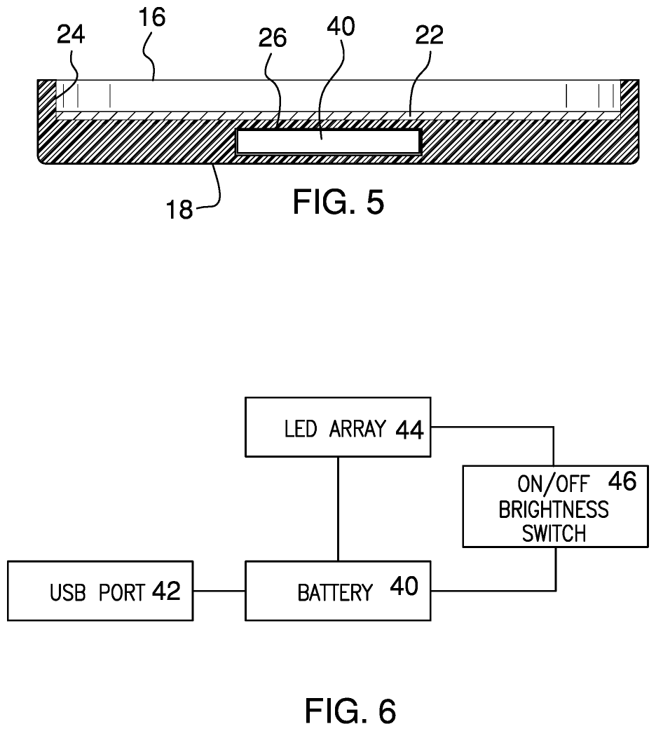

With reference now to the drawings, and in particular to FIGS. 1 through 6 thereof, a new compact case embodying the principles and concepts of an embodiment of the disclosure and generally designated by the reference numeral 10 will be described.

As best illustrated in FIGS. 1 through 6, the illuminated compact case 10 generally comprises a housing 12 that defines an interior space 14. The housing 12 has a top 16 that is open and a bottom 18 that is magnetic. The top 16 of the housing 12 is configured to insert paramagnetic articles, such as makeup pans, into the interior space 14 to selectively couple the paramagnetic articles to the bottom 18 of the housing 12. In one embodiment, the housing 12 is substantially rectangularly box shaped. The housing 12 has front edges 20. In another embodiment, the front edges 20 are arcuate.

In one embodiment, a plate 22 is positioned in the interior space 14 and is coupled to an interior surface 24 of the housing 12 to define a chamber 26. The plate 22 is magnetic. The plate 22 is configured to selectively couple to the paramagnetic articles to couple the paramagnetic articles to the housing 12. In another embodiment, the housing 12 comprises plastic.

A lid 28 is hingedly coupled to a back edge 30 of the housing 12. The lid 28 is complementary to the top 16. The lid 28 is positioned to selectively close the top 16. A mirror 32 is coupled to an inner face 34 of the lid 28 and defines a border 36 between the mirror 32 and a perimeter 38 of the lid 28. The mirror 32 is configured to reflect an image of a user. In one embodiment, the mirror 32 is concavely shaped so that the mirror 32 is configured to reflect an enlarged image of the user. In another embodiment, the mirror 32 is shaped substantially complementarily to the lid 28.

At least one battery 40 is coupled to the housing 12. The at least one battery 40 is rechargeable. In one embodiment, the battery 40 is positioned in the chamber 26. A universal serial bus port 42 is coupled to the housing 12. The universal serial bus port 42 is operationally coupled to the at least one battery 40. The universal serial bus port 42 is configured to couple the at least one battery 40 to a source of direct current to recharge the at least one battery 40.

A plurality of light emitting diodes 44 is coupled to the border 36. The plurality of light emitting diodes 44 is operationally coupled to the at least one battery 40. The plurality of light emitting diodes 44 is configured to selectively illuminate an area proximate to the lid 28.

A controller 46 is coupled to the lid 28. The controller 46 is operationally coupled to the plurality of light emitting diodes 44 and the at least one battery 40. The controller 46 is positioned to adjust a brightness of the plurality of light emitting diodes 44. In one embodiment, the controller 46 comprises a slide switch 48.

In use, the top 16 of the housing 12 is configured to insert the paramagnetic articles, such as the makeup pans, into the interior space 14. The plate 22 is configured to selectively couple to the paramagnetic articles to couple the paramagnetic articles to the housing 12. The lid 28 is positioned to selectively close the top 16. The mirror 32 that is positioned on the lid 28 is configured to reflect the image of the user. The plurality of light emitting diodes 44 that is positioned on the border 36 is configured to selectively illuminate the area proximate to the lid 28. The universal serial bus port 42 that is positioned on the housing 12 is configured to couple the at least one battery 40 to the source of direct current to recharge the at least one battery 40. The slide switch 48 that is positioned on the lid 28 is positioned to adjust the brightness of the plurality of light emitting diodes 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminated compact case comprising:
a housing defining an interior space, said housing having a top, said top being open, said housing having a bottom, said bottom being magnetic;
a lid hingedly coupled to a back edge of said housing, said lid being complementary to said top;
a mirror coupled to an inner face of said lid defining a border between said mirror and a perimeter of said lid;
at least one battery coupled to said housing, said at least one battery being rechargeable;
a universal serial bus port coupled to said housing, said universal serial bus port being operationally coupled to said at least one battery;
a plurality of light emitting diodes coupled to said border, said plurality of light emitting diodes being operationally coupled to said at least one battery; and
wherein said top of said housing is open such that said top is configured for inserting paramagnetic articles into said interior space for selectively coupling the paramagnetic articles to said bottom of said housing, wherein said lid is positioned on said housing such that said lid is positioned for selectively closing said top, wherein said mirror is positioned on said lid such that said mirror is configured for reflecting an image of a user, wherein said plurality of light emitting diodes is positioned on said border such that said plurality of light emitting diodes is configured for selectively illuminating an area proximate to said lid, wherein said universal serial bus port is positioned on said housing such that said universal serial bus port is configured for coupling said at least one battery to a source of direct current for recharging said at least one battery.

2. The case of claim 1, further including said housing being substantially rectangularly box shaped.

3. The case of claim 2, further including said housing having front edges, said front edges being arcuate.

4. The case of claim 1, further including a plate positioned in said interior space and coupled to an interior surface of said housing defining a chamber, said plate being magnetic, wherein said plate is positioned in said interior space such that said plate is configured for selectively coupling to the paramagnetic articles to couple the paramagnetic articles to said housing.

5. The case of claim 4, further including said housing comprising plastic.

6. The case of claim 1, further including said mirror being concavely shaped such that said mirror is configured for reflecting an enlarged image of the user.

7. The case of claim 1, further including said mirror being shaped substantially complementarily to said lid.

8. The case of claim 4, further including said battery being positioned in said chamber.

9. The case of claim 1, further including a controller coupled to said lid, said controller being operationally coupled to said plurality of light emitting diodes and said at least one battery, wherein said controller is positioned on said lid such that said controller is positioned for adjusting a brightness of said plurality of light emitting diodes.

10. The case of claim 9, further including said controller comprising a slide switch.

11. An illuminated compact case comprising:
a housing defining an interior space, said housing having a top, said top being open, said housing having a bottom, said bottom being magnetic, wherein said top of said housing is open such that said top of said housing is configured for inserting paramagnetic articles into said interior space for selectively coupling the paramagnetic articles to said bottom of said housing, said housing comprising plastic, said housing being substantially rectangularly box shaped, said housing having front edges, said front edges being arcuate;
a plate positioned in said interior space and coupled to an interior surface of said housing defining a chamber, said plate being magnetic, wherein said plate is positioned in said interior space such that said plate is configured for selectively coupling to the paramagnetic articles to couple the paramagnetic articles to said housing;
a lid hingedly coupled to a back edge of said housing, said lid being complementary to said top, wherein said lid is positioned on said housing such that said lid is positioned for selectively closing said top;
a mirror coupled to an inner face of said lid defining a border between said mirror and a perimeter of said lid, wherein said mirror is positioned on said lid such that said mirror is configured for reflecting an image of a user, said mirror being concavely shaped such that said mirror is configured for reflecting an enlarged image of the user, said mirror being shaped substantially complementarily to said lid;
at least one battery coupled to said housing, said at least one battery being rechargeable, said battery being positioned in said chamber;
a universal serial bus port coupled to said housing, said universal serial bus port being operationally coupled to said at least one battery, wherein said universal serial bus port is positioned on said housing such that said universal serial bus port is configured for coupling said at least one battery to a source of direct current for recharging said at least one battery;
a plurality of light emitting diodes coupled to said border, said plurality of light emitting diodes being operationally coupled to said at least one battery, wherein said plurality of light emitting diodes is positioned on said border such that said plurality of light emitting diodes is configured for selectively illuminating an area proximate to said lid;
a controller coupled to said lid, said controller being operationally coupled to said plurality of light emitting diodes and said at least one battery, wherein said controller is positioned on said lid such that said controller is positioned for adjusting a brightness of said plurality of light emitting diodes, said controller comprising a slide switch; and
wherein said top of said housing is open such that said top of said housing is configured for inserting the paramagnetic articles into said interior space, wherein said plate is positioned in said interior space such that said plate is configured for selectively coupling to the paramagnetic articles to couple the paramagnetic articles to said housing, wherein said lid is positioned on said housing such that said lid is positioned for selectively closing said top, wherein said mirror is positioned on said lid such that said mirror is configured for reflecting the image of the user, wherein said plurality of light emitting diodes is positioned on said border such that said plurality of light emitting diodes is configured for selectively illuminating the area proximate to said lid, wherein said universal serial bus port is positioned on said housing such that said universal serial bus port is configured for coupling said at least one battery to the source of direct current for recharging said at least one battery, wherein said controller is positioned on said lid such that said controller is positioned for adjusting the brightness of said plurality of light emitting diodes.
